(19) United States
(12) Patent Application Publication
(10) Pub. No.: US 2002/0168450 A1
(43) Pub. Date: Nov. 14, 2002

(54) Melting body

(76) Inventors: Jaime Drudis, Heilbronn (DE); Richard Kellermann, Gemmingen-Stebbach (DE); Kristine Obenland, Heilbronn (DE); Johannes Schupp, Erlenbach (DE); Gila Seewi, Heilbronn (DE); Rainer Wiesbecker, Bad Orb (DE)

Correspondence Address: UNILEVER, PATENT DEPARTMENT, 45 RIVER ROAD, EDGEWATER, NJ, 07020, US

(21) Appl. No.: 09/995,929

(22) Filed: Nov. 28, 2001

(30) Foreign Application Priority Data
Nov. 28, 2000 (DE) 10058926.6

(51) Int. Cl. A23L 1/00

(52) U.S. Cl. 426/89

(57) ABSTRACT

The invention relates to a melting body for introducing organoletical

The present invention relates to a melting body for introducing organoleptically active additives to foods.

In the food industry, it is known to encapsulate seasonings in particular in fats. A review of this method is found in International Journal of Food Sciences and Nutrition (1999) 50, 213-224. The capsules consist of a matrix of encapsulation material in which the constituents are distributed, or the capsules consist of an outer wall of the encapsulation material which encloses the constituents in the core. Such capsules generally have a particle size of 5-300 microns in diameter. Larger capsules up to 2 mm are also described.

Various food additives can be encapsulated by this technique, for example seasonings such as oils, spices and flavourings. The constituents are released by melting the capsules.

Such encapsulated material can also be compressed to form larger bodies, for example tablets or pellets (WO 88/02221, DE-A 3541304).

These products have numerous disadvantages:

They must be handled as powders which are difficult to handle and dose. They require an aid, for example a spoon, for their handling and have a tendency to sinter and clump on storage. In contrast, if they are compressed to form larger shaped bodies, the melting behaviour suffers from this, they are not readily dissolvable in the hot ready-to-eat food and the melting time is increased by the pressing, possibly in a mixture with powder constituents. A simple coating of liquid or semi-liquid constituents is completely impossible. Such encapsulated liquid or semi-liquid products also have a tendency for oil release during storage. In addition, an effective coating requires a reasonably high amount of fat, if fat is used as coating material, in comparison with the amount of the filler material to be coated.

These disadvantages are overcome by the melting body of the invention.

The inventive melting body for introducing organoleptically active additives to foods consists of a transport-stable outer wall which dissolves in the food and releases the contents and which encloses a filling comprising these additives.

The inventive melting body can have differing geometric shapes. Preference is given to the shape of cubes, because these may be packaged particularly readily and the shape of the spheres, because this shape ensures the highest stability and has the most favourable ratio between wall material and content.

The inventive melting body generally has a size corresponding to a diameter of 1-5 cm, preferably 2-4 cm. In the case of a spherical shape this dimension designates the outer diameter, and in the case of a cubic shape the edge length. Such relatively large bodies can be handled easily without aids, give a favourable ratio of wall material to content and permit an expedient portioning of the contents in that they comprise a defined amount of one portion or half a portion.

The inventive melting bodies expediently have an overall weight of 4-100 g, preferably 8-30 g.

The outer wall of the melting bodies generally has a thickness of 2-8, preferably 3-6, mm.

Expediently, the inventive melting body consists of 40-90% by weight, preferably 65-85% by weight, of wall material and correspondingly 10-60% by weight, preferably 15-35% by weight, of filling.

A suitable wall material is any material which is dimensionally stable and ensures stability of the body during transport and handling, cannot be dissolved or penetrated by the constituent, but dissolves in the food and releases the contents of the melting body.

In principle, therefore, the outer wall can consist of a material which dissolves in the liquid phase of the food at room temperature. However, preference is given to a wall material which melts at the elevated temperature of the food which is being prepared hot, for example a hard fat or a suitable fat mixture, which has a melting point in the range of the temperatures which hot foods customarily have. Preference is therefore given to a melting point in the range 30-80° C., preferably 40-70° C.

The wall material must have properties such that, after the melting and its distribution in the food, it does not solidify on its cooling to consumption temperature and impair the organoleptic properties of the food. A fat which, in the small amount in which it passes into the food, may be readily emulsified or distributed decreases the risk of organoleptic impairment.

Suitable fats, in particular vegetable fats, are commercially available, for example the product Chocovit U6® from Noblee & Thörl GmbH, which has the following specification:

| Refractive index n_{D}⁴⁰ | | 1.457-1.459 |
|---|---|---|
| Drop point | | 36-41° C. |
| Slip point | | 35-38° C. |
| Saponification value | | 195-203 |
| Iodine value (Wijs) | | 52-58 |
| Peroxide value (meq O₂/kg) | | max. 0.5 |
| Free fatty acid (oleic acid) | | max. 0.1% |
| Solid fatty content at | 10° C. | 86-92% |
| | 20° C. | 65-73% |
| | 30° C. | 30-36% |
| Fatty acid profile (% of total fatty acids) | | |
| C 12:0 | | max. 0.5 |
| C 14:0 | | 0.9-1.4 |
| C 16:0 | | 32-36 |
| C 18:0 | | 3-5 |
| C 18:1 | | 43-48 |
| C 18:2 | | 7-13 |
| Other fatty acids | | max. 2 |

The outer wall can also consist of a fat-containing binder (roux). Particular preference is given to a plastic binder as prepared by the process of EP 112 504-B1, that is to say by mixing a starch material with a possibly liquefied edible fat and subsequent heat treatment at a temperature of 90-150° C.

A suitable filling is any organoleptically active material which is to be added in small amounts to foods. It can be pulverulent, liquid or semi-liquid. In particular, however, the invention is intended for introducing seasoning or aromatizing agent into a food and, more precisely, preferably fat- or oil-based seasoning. However, in principle, it is also possible to provide a water-based filling or fillings in an alcohol-containing medium. Suitable fillings are also substances which are sensitive to oxidation and are protected against oxidation in the inventive melting body.

Examples of fillings are herb-containing sauce-based products for preparing pasta products, fish pastes, dried consommé, pepper sauces, sherry-containing gourmet sauces.

The invention is particularly suitable for adding herb/spice mixtures in an oil base, for example to cooked pasta products, soups, sauces, vegetable preparations shortly before consumption. The filling can, furthermore, comprise other additives, for example salt, starch, flavour substances, spices etc. The outer wall melts rapidly in the hot food and the contents are distributed in the food.

The invention also makes possible a longer storage life of the filler material, since it is hermetically enclosed by the outer wall and is protected against oxidation and other environmental influences.

A particularly suitable filling consists of freeze-dried herbs, for example thyme, oregano or basil, suspended in an oil, for example olive oil. Melting bodies with fillings of this type are used, in particular, to prepare pasta products, for example spaghetti.

The inventive melting bodies can also be produced according to known technology, as is used, for example, in the manufacture of chocolates. The fat to be used as wall material is melted and crystallized in moulds. The moulds are filled with the filler material and sealed, for example by applying a cover portion.

Solid fillings can be coated with the outer wall by a dipping process.

### EXAMPLE 1

Round melting bodies having a diameter of 2.5 cm were produced by 70% by weight of wall material and 30% by weight of filling. The wall material consisted of a vegetable fat of the brand Chocovit U6® having a drop point of 39° C.

The filling consisted of a mixture of:

33% by weight of plasticized fat

7% by weight of fat powder

30% by weight of herbs

17% by weight of salt

13% by weight of potato starch

The melting body produced from these constituents is particularly suitable for preparing pasta products. It can for example be added to hot, freshly prepared pasta either directly in the cooking pot after draining of the boiling water or placed on the plate and mixed with the pasta.

### EXAMPLE 2

Melting bodies in cube shape having an edge length of 3 cm were produced from 80% by weight of the same wall material as in Example 1 and 20% by weight of filling.

The filling contained semi-liquid fat, butter flavour, salt, lecithin and a herb mixture of thyme, oregano and basil.

The melting body was placed onto a plate of hot Spaghetti and mixed with the same.

### EXAMPLE 3

Round melting bodies having a diameter of 2 cm were produced from 75% by weight of wall material and 25% by weight of filling. The wall material used was the same fat as in Example 1. The filling consisted of 53% by weight of sunflower seed oil, 13% by weight of salt, 13% by weight of monosodium glutamate and 21% by weight of the same herb mixture as in Example 2.

The melting bodies were mixed with hot, ready-to-eat Maccaroni.

### EXAMPLE 4

A filling suitable as pepper sauce was produced from the following constituents:

| | |
|---|---|
| Special waxy starch | 4.0 g |
| Maize germ oil | 2.5 g |
| Common salt | 2.3 g |
| Sodium glutamate | 1.0 g |
| Yeast extract powder | 1.0 g |
| Onion powder | 0.8 g |
| Pepper, green, freeze-dried | 0.8 g |
| Pepper white | 0.4 g |
| Fat powder | 8.0 g |
| Chives | 0.2 g |
| Sherry, liquid | 2.0 g |
| | 23.0 g |

This filling was given an outer wall which consisted of the following constituents:

| | |
|---|---|
| roux light, produced according | 31.6 g |
| to Example 1 of EP 112 504-B1 | |
| Instant caramel | 1.4 g |
| Paprika oil | 1.0 g |
| | 34.0 g |

Cubes having an edge length of about 2.5 cm were produced from in each case 5 g of filler material and 11 g of outer wall material.

The cubes have good shelf-stability. A cube was stirred into 125 ml of boiling water and after short boiling (1-5 minutes) produced a ready-to-eat pepper sauce.

### EXAMPLE 5

The following fillings were processed with an outer wall material according to Example 4:

a)

| Fish paste | (g) |
|---|---|
| Onion | 200 |
| Tomato puree | 150 |
| Fish powder | 130 |
| Peppers | 60 |
| Salt | 55 |
| Glutamate | 20 |
| Garlic powder | 15 |
| Yeast extract | 15 |
| Citric acid | 1 |
| Spice | 3 |
| Total: | 649 |

b)

| Consomme dried | (g) |
|---|---|
| Meat broth, dried | 780 |
| Salt | 530 |
| Sugar | 60 |
| Yeast extract | 50 |
| Vegetables dried | 18 |
| Spice | 2 |
| Maltodextrin | 150 |
| Fat | 1750 |
| Total: | 3340 |

c)

| Pepper sauce (dry) | (g) |
|---|---|
| Salt | 60 |
| Onion powder | 12 |
| Pepper | 18 |
| Spice preparation | 87 |
| Fat powder | 250 |
| Fat | 90 |
| Chives | 3 |
| Total: | 520 |

a) 16 g of the fish paste as filler material and 11 g of the outer wall material according to example 4 were processed into a melting body.

b) 6 g of the consommé as filler material and 8 g of the outer wall material according to example 4, however without the coloring additives caramel and peppers, were processed into a melting body.

c) 8,5 g of the pepper sauce (dry) as filler material and 11 g of the outer wall material according to example 4 were processed into a melting body.

The melting bodies were worked into a ready-to-eat sauce as described in example 4.

1. Melting body for introducing organoleptically active additives to foods consisting of a transport-stable outer wall which dissolves in the food and releases the contents and which encloses a filling comprising these additives.

2. Melting body according to claim 1, characterized in that the outer wall consists of hard fat which has a melting point in the range of the temperatures which hot foods customarily have.

3. Melting body according to claim 1, characterized in that the outer wall material has a melting point of 30-80° C., preferably 40-70° C.

4. Melting body according to claim 1, characterized in that it has a size corresponding to a diameter 1-5 cm, preferably 2-4 cm.

5. Melting body according to claim 1, characterized in that the filling is a seasoning.

6. Melting body according to claim 1, characterized in that the filling comprises a fat- or oil-based seasoning.

7. Melting body according to claim 1, characterized in that it consists of 40-90% by weight, preferably 65-85% by weight, of wall material and 10-60% by weight, preferably 15-35% by weight, of filling.

8. Melting body according to claim 1, characterized in that it has the shape of a cube or a sphere.
